(19) United States
(12) Patent Application Publication
(10) Pub. No.: US 2005/0111708 A1
(43) Pub. Date: May 26, 2005

(54) Sweep-type fingerprint sensor device capable of guiding a finger in a fixed sweeping direction

(76) Inventor: Bruce C. S. Chou, Hsin Chu (TW)

Correspondence Address: BIRCH STEWART KOLASCH & BIRCH, PO BOX 747, FALLS CHURCH, VA, 22040-0747, US

(21) Appl. No.: 10/920,255

(22) Filed: Aug. 18, 2004

(30) Foreign Application Priority Data
Nov. 20, 2003 (TW) 092132481

(51) Int. Cl. G06K 9/00

(52) U.S. Cl. 382/124

(57) ABSTRACT

A sweep-type fingerprint sensor device capable of guiding a finger in a fixed sweeping direction includes a sweep-type fingerprint sensor and a T/G (Transmission and Guiding) mechanism. The sweep-type fingerprint sensor senses a plurality of fingerprint fragment images from the finger that sweeps across a sensor surface of the sweep-type fingerprint sensor in the sweeping direction. The T/G mechanism is arranged beside the sweep-type fingerprint sensor and may be driven along a guiding direction corresponding to the sweeping direction in order to guide the finger to stably sweep across the sensor surface. The sweep-type fingerprint sensor device may further include a micro switch, a speed/displacement sensor or a driving mechanism for performing the operation of power control, speed/displacement detection, or driving the finger to sweep.

### BACKGROUND OF THE INVENTION

1. Field of the Invention

The invention relates to a sweep-type fingerprint sensor device capable of guiding a finger in a fixed sweeping direction, and more particularly to a sweep-type fingerprint sensor device capable of effectively preventing the finger from shaking when it is sweeping so as to improve the sensing quality of the sweep-type fingerprint sensor device. The invention also relates to the commonly assigned U.S. patent application Ser. No. 10/441,022, filed on May 20, 2003, and entitled “SWEEP-TYPE FINGERPRINT SENSOR MODULE AND A SENSING METHOD THEREFOR”.

2. Description of the Related Art

There are many known techniques of identifying an individual through the identification of the individual's fingerprint. The use of an ink pad and the direct transfer of ink by the thumb or finger from the ink pad to a recording card is the standard way of making this identification. Then, an optical scanner scans the recording card to get an image, which is then compared to the fingerprint image stored previously in the computer database. However, the most serious drawback of the above-mentioned method is that the fingerprint identification cannot be processed in real-time, and thus cannot satisfy the requirement of real-time authentication, such as the network authentication, e-business, portable electronics products, personal ID card, security system, and the like.

The method for reading a fingerprint in real-time has become the important technology in the biometrics market. Conventionally, an optical fingerprint sensor may be used to read a fingerprint in real-time. However, the optical fingerprint sensor has a drawback because it is large in size, expensive in price and limitation use in a dirty and dry finger. Consequently, silicon fingerprint sensors, which overcome the drawbacks of the optical sensor and are formed by silicon semiconductor technology, are developed.

Owing to the finger dimension, the sensing area of the conventional silicon fingerprint sensor is large, for example, it is greater than 9 mm*9 mm. Furthermore, owing to the limitations in manufacturing the silicon integrated circuit, only 50 to 70 good dies may be formed in a 6″ wafer. The price of a single fingerprint sensor is greater than at least 10 U.S. dollars when the packaging and testing costs are included. Thus, this expensive price may restrict the silicon fingerprint sensor in various consumer electronics applications such as the notebook computers, mobile phones, personal digital assistants, computer peripheral product, or even personal ID cards embedded with the fingerprint sensor.

Consequently, it is possible to reduce one-dimensional width of the conventional, two-dimensional (2D) silicon fingerprint sensor so as to increase the number of good dies and decrease the price of the sensor chip. In this case, the finger sweeps across the sensor surface and the overall finger is sequentially scanned into plural fingerprint fragment images, which are then reconstructed into a complete fingerprint image.

However, because the finger tends to shake laterally when it sweeps across the sweep-type fingerprint sensor, the subsequent process for reconstructing the fingerprint fragment images sensed by the fingerprint sensor becomes more and more complex. Furthermore, the sweeping speed of the finger across the sensor depends on the user's inertial behavior and varies accordingly, so the conventional designer has to assume that the finger sweeping speed is within a predetermined range or request the typical users to practice the sweeping speed within the predetermined range so that the acquiring time period of each fragment image and the interval between two fragment images may be obtained. If the sweeping speed of some user is out of the designed range, the fingerprint cannot be correctly sensed. So, the conventional way is labersome and decreases the user's interest of use.

### SUMMARY OF THE INVENTION

It is therefore an object of the invention to provide a sweep-type fingerprint sensor device capable of guiding a finger in a fixed sweeping direction and effectively preventing the jitters of the finger caused during the sweeping process.

Another object of the invention is to provide a sweep-type fingerprint sensor device with power on function as the finger touches the sensor device.

Still another object of the invention is to provide a sweep-type fingerprint sensor device with speed or displacement detection function for detecting the sweeping speed or displacement of the finger and thus detecting a plurality of fingerprint fragment images of the finger according to the detected sweeping speed or displacement.

To achieve the above-mentioned objects, the invention provides a sweep-type fingerprint sensor device capable of guiding a finger in a fixed sweeping direction. The sensor device includes a sweep-type fingerprint sensor and a T/G (Transmission and Guiding) mechanism. The sweep-type fingerprint sensor senses a plurality of fingerprint fragment images from a finger that sweeps across a sensor surface of the sweep-type fingerprint sensor in a sweeping direction. The T/G mechanism is arranged beside the sweep-type fingerprint sensor and may be driven along a guiding direction corresponding to the sweeping direction in order to guide the finger to stably sweep across the sensor surface. The sweep-type fingerprint sensor device may further include a micro switch, a speed/displacement sensor or a driving mechanism for performing the operation of power control, speed/displacement detection, or driving the finger to sweep.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a schematic top view showing a sweep-type fingerprint sensor device according to a first embodiment of the invention.

FIG. 2 is a schematically cross-sectional view taken along a line 2-2 of FIG.

FIG. 3 is a schematically cross-sectional view taken along a line 3-3 of FIG. 1 to show a modified embodiment.

FIG. 4 is a side view showing the roller and the speed/displacement sensor of FIG. 2.

FIG. 5 is a front view showing the roller of FIG. 2.

FIG. 6 is a schematic top view showing a sweep-type fingerprint sensor device according to a second embodiment of the invention.

FIG. 7 is a schematic top view showing a sweep-type fingerprint sensor device according to a third embodiment of the invention.

### DETAILED DESCRIPTION OF THE INVENTION

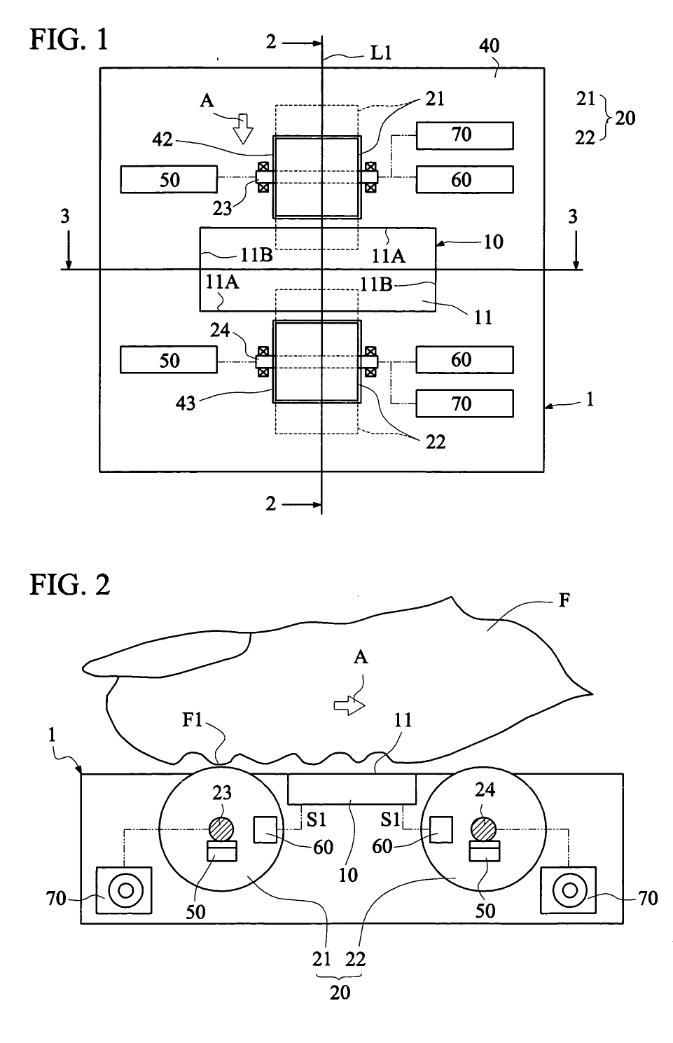

FIG. 1 is a schematic top view showing a sweep-type fingerprint sensor device according to a first embodiment of the invention. FIG. 2 is a schematically cross-sectional view taken along a line 2-2 of FIG. 1. Referring to FIGS. 1 and 2, the sweep-type fingerprint sensor device 1 of this embodiment includes a sweep-type fingerprint sensor 10, a T/G (Transmission and Guiding) mechanism 20, a panel 40, two micro switches 50, two speed/displacement sensors 60, and two driving mechanisms 70. The sweep-type fingerprint sensor 10 has a rectangular sensor surface 11 for sensing a plurality of fingerprint fragment images of a finger F sweeping in a sweeping direction A. These fingerprint fragment images are transferred to a microprocessor (not shown) for image reconstruction. The T/G mechanism 20 for guiding the finger F in a stable sweeping direction across the sensor surface 11 is disposed beside the sweep-type fingerprint sensor 10 and is driven along a guiding direction corresponding to the sweeping direction A.

In this embodiment, the T/G mechanism 20 includes two rollers 21 and 22, and the sweep-type fingerprint sensor 10 is positioned between the two rollers 21 and 22. The sweep-type fingerprint sensor 10 and the T/G mechanism 20 composed of the rollers 21 and 22 are arranged in one straight line L1 along the sweeping direction A. That is, the guiding direction of the T/G mechanism 20 is perpendicular to a long edge 11A of the rectangular sensor surface 11 of the sweep-type fingerprint sensor 10. The roller 21 is located in front of the sweep-type fingerprint sensor 10 or at a side of the long edge 11A of the rectangular sensor surface 11 such that a specific portion F1 of the finger F may firstly move across the roller 21 and then the sensor surface 11. The roller 22 is located in back of the sweep-type fingerprint sensor 10 or at the other side of the long edge 11A of the rectangular sensor surface 11 such that the specific portion F1 of the finger F may firstly move across the sensor surface 11 and then the roller 22. In fact, only one of the rollers 21 and 22 may achieve the effect of the invention. The finger F having its sweeping inertia along the sweeping direction A under the guiding of the roller 21 and/or 22 will follow the rolling inertia of the roller when sweeping across the sensor surface and ensure the sweeping behavior in an almost straight direction to avoid unclear image reconstruction due to finger shaking and so on. So, the jitters in the left and right directions perpendicular to the sweeping direction A when the finger F sweeps across may be effectively eliminated.

In other embodiments, the T/G mechanism may be a caterpillar T/G mechanism that is similar to the sheet-feeding mechanism of a copier, wherein the caterpillar cooperates with the finger to achieve the effect of the invention.

The micro switch 50 is an optional member to be in contact with the rollers 21 and 22 of the T/G mechanism 20. When the finger F contacts the rollers 21 and 22 of the T/G mechanism 20, the micro switch 50 may be triggered and thus turn on the power of the sweep-type fingerprint sensor 10. In this condition, the main power of the fingerprint sensor 10 need not to be always turned on. Instead, the main power may be turned on by the pressing of the finger F on the rollers 21 and 22 of the T/G mechanism 20 to trigger the micro switch 50 when needed.

The speed/displacement sensor 60 is also an optional member for sensing a rotating speed or a displacement of the T/G mechanism 20, and then outputting a rotating speed signal or a displacement signal S1 to the microprocessor (not shown), such that the microprocessor determines the minimum number of the to-be-acquired fingerprint fragment images and thus a plurality of fingerprint fragment images is acquired according to the rotating speed signal or the displacement signal S1. For example, the direction of the speed/displacement may be determined in the opto-electronic manner, the electric manner, the magnetic force manner, and the like, which are to be described later. Because the sweeping speed of the finger during the sensing process of the fingerprint may be regarded as constant, the sensing time interval between two adjacent fingerprint fragment images may be optimized when the rotating speed of the T/G mechanism 20 is already known, and the subsequent image reconstruction procedure may be facilitated.

The driving mechanism 70 such as a motor is also an optional member for driving the T/G mechanism 20 to rotate so as to drive the finger F to sweep across the sensor surface 11. As a result, the driving speed of the driving mechanism 70 is known, and the sensing time interval between two adjacent fingerprint fragment images also may be optimized without worrying about the slight fluctuations of the sweeping speed of the user's finger during this period of time. In addition, the finger's sweeping direction may also be fixed.

In this embodiment, the panel 40 is a flat panel, and the sweep-type fingerprint sensor 10 and the T/G mechanism 20 are disposed on the panel 40. The width of the T/G mechanism 20 may be greater than, smaller than or equal to that of the fingerprint sensor 10. Each of the rollers 21 and 22 has an exposed portion exposed from each of the openings 42 and 43 (as indicated by the rectangles defined by the solid lines) of the panel 40 so as to contact the finger while rotating about the shafts 23 and 24.

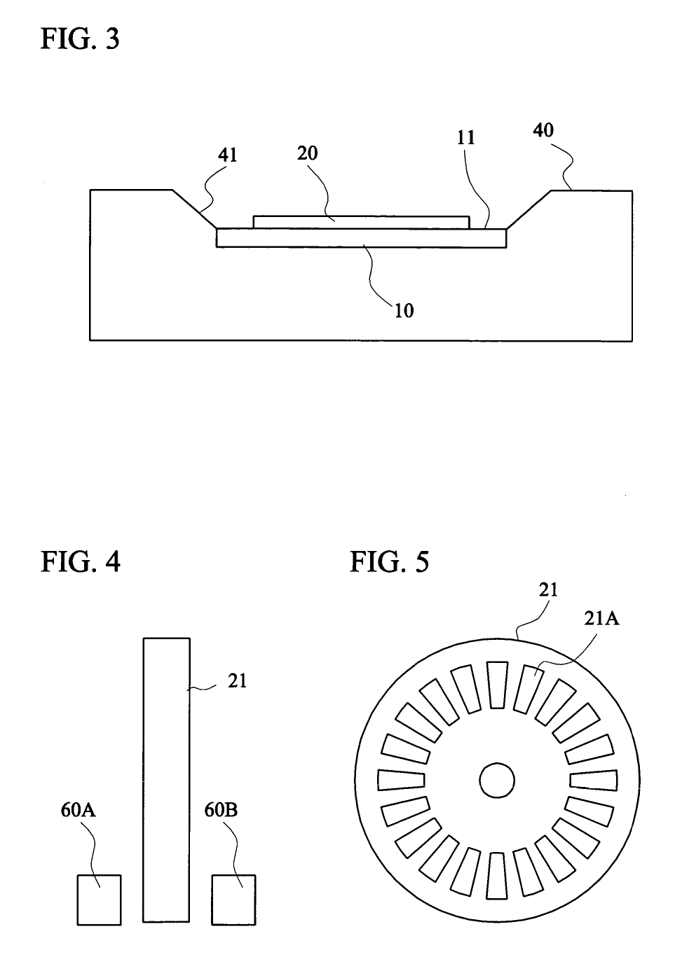

FIG. 3 is a schematically cross-sectional view taken along a line 3-3 of FIG. 1 to show a modified embodiment. In this modified embodiment, the panel 40 has a U-shaped groove 41, in which the sweep-type fingerprint sensor 10 and the T/G mechanism 20 are disposed. The T/G mechanism 20 may be flush with or higher than the sweep-type fingerprint sensor 10.

The speed/displacement detection may be achieved in the opto-electronic manner to be described in the following. FIG. 4 is a side view showing the roller and the speed/displacement sensor of FIG. 2. FIG. 5 is a front view showing the roller of FIG. 2. It is to be noted that the difference between the speed and displacement detections is only in that the speed detection takes the time into account, while the displacement detection does not. The emitter 60A of the speed/displacement sensor 60 continuously emits a signal (such as infrared signal). Because the signal can only pass through the openings 21A of the roller 21, the receiver 60B discontinuously receives this emitted signal, which discontinuously penetrates through the openings 21A of the roller 21, so as to generate several pulses as the displacement signal. By calculating the pulse number per unit time, the roller's rotation speed, which may correspond to the finger's sweeping speed, may be obtained.

On the other hand, if the time is not taken into account, the sweep-type fingerprint sensor device may be configured such that the fingerprint sensor starts to acquire one fingerprint fragment image each time when the receiver 60B receives one pulse. Such a design may be easily accomplished according to the rotating angle of the roller 21 and the finger's sweeping displacement corresponding to the arc length between two adjacent openings 21A of the roller 21. In this condition, even if the finger's sweeping speed fluctuation is larger, the acquiring of the fingerprint fragment images also cannot be influenced. In brief, if the width (the length in the direction A) of the fingerprint sensor is known, the displacement corresponding to the rotating roller's opening 21A may be configured such that the sensor acquires one fingerprint fragment image each time when the pulse signal appears. In this way, the sweeping speed need not to be detected.

The transmittive speed/displacement sensor 60 mentioned in the example also may be replaced by a reflective speed/displacement sensor. In this case, the emitter 60A and receiver 60B are located at the same side of the roller 21. Forming patterns, which correspond to the openings 21A, on the surface of the roller 21 may enable the receiver 60B to receive the emitted signal reflected by the roller 21 so as to generate several pulses as the displacement signal.

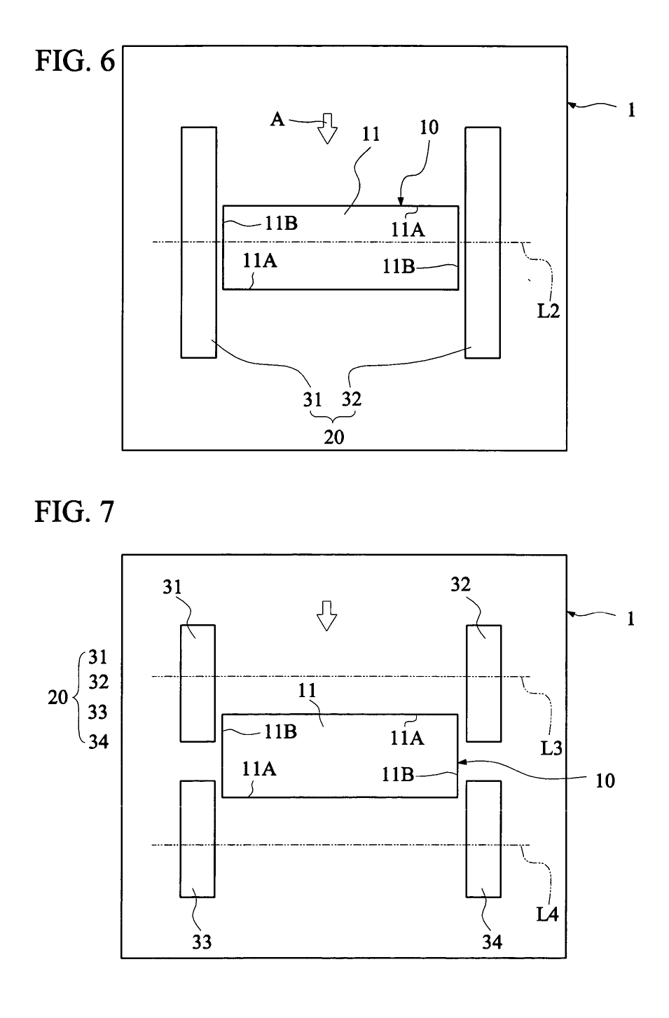

FIG. 6 is a schematic top view showing a sweep-type fingerprint sensor device according to a second embodiment of the invention. The embodiment is similar to the first embodiment except for the difference to be described in the following. In this embodiment, the sweep-type fingerprint sensor 10 and the T/G mechanism 20 are arranged in one straight line L2 in a direction substantially perpendicular to the sweeping direction A. The T/G mechanism 20 comprises two rollers 31 and 32, which are located at two sides of the short edge 11B of the rectangular sensor surface 11 of the sweep-type fingerprint sensor 10, respectively, in order to guide the finger between the two rollers 31 and 32 to sweep across the fingerprint sensor 10.

FIG. 7 is a schematic top view showing a sweep-type fingerprint sensor device according to a third embodiment of the invention. The embodiment is similar to the second embodiment except for the difference to be described in the following. In this embodiment, the T/G mechanism 20 comprises four rollers 31 to 34, wherein the rollers 31 and 32 are arranged in a straight line L3, and the rollers 33 and 34 are arranged in a straight line L4. The two straight lines L3 and L4 are substantially perpendicular to the sweeping direction A, and the sensor surface 11 is located between the straight lines L3 and L4. The straight lines L3 and L4 are substantially parallel to the long edge 11A of the rectangular sensor surface 11 of the sweep-type fingerprint sensor 10. The straight line L3 is located at one side of the long edge 11A of the rectangular sensor surface 11, while the straight line L4 is located at the other side of the long edge 11A of the rectangular sensor surface 11.

In a modified embodiment, the rollers 33 and 34 may be omitted. In this case, the straight line L3 is located in front of the sensor surface 11 such that a specific portion F1 (FIG. 2) of the finger F firstly passes through the straight line L3 and then the sensor surface 11.

In another modified embodiment, the rollers 31 and 32 may be omitted. In this case, the straight line L4 is located in back of the sensor surface 11 such that a specific portion F1 (FIG. 2) of the finger F firstly passes through the sensor surface 11 and then the straight line L4.

According to the structure of the invention, the jitters generated when the finger sweeps across the sensor may be effectively avoided, the fingerprint sensor also may be powered according to the provided switch function, and the finger's sweeping speed or sweeping distance also may be detected to serve as the basis for sensing the finger's fingerprint fragment images.

While the invention has been described by way of examples and in terms of preferred embodiments, it is to be understood that the invention is not limited to the disclosed embodiments. To the contrary, it is intended to cover various modifications. Therefore, the scope of the appended claims should be accorded the broadest interpretation so as to encompass all such modifications.

1. A sweep-type fingerprint sensor device capable of guiding a finger in a fixed sweeping direction, the sensor device comprising:
a sweep-type fingerprint sensor for sensing a plurality of fingerprint fragment images from the finger sweeping across a sensor surface of the sweep-type fingerprint sensor in the sweeping direction; and
a T/G (Transmission and Guiding) mechanism, which is arranged beside the sweep-type fingerprint sensor and may be driven along a guiding direction corresponding to the sweeping direction in order to guide the finger to stably sweep across the sensor surface.

2. The device according to claim 1, wherein the sensor surface is rectangular, and the guiding direction of the T/G mechanism is perpendicular to a long edge of the rectangular sensor surface of the sweep-type fingerprint sensor.

3. The device according to claim 2, wherein the T/G mechanism comprises a roller, which is located at a side of the long edge of the rectangular sensor surface of the sweep-type fingerprint sensor such that a specific portion of the finger firstly passes through the roller and then the sensor surface or firstly passes through the sensor surface and then the roller.

4. The device according to claim 2, wherein the T/G mechanism comprises two rollers, which are located at two sides of the long edge of the rectangular sensor surface of the sweep-type fingerprint sensor, respectively.

5. The device according to claim 2, wherein the T/G mechanism comprises two rollers, which are located at two sides of a short edge of the rectangular sensor surface of the sweep-type fingerprint sensor.

6. The device according to claim 2, wherein the T/G mechanism comprises two rollers, which are arranged in a straight line, which is substantially parallel to the long edge of the rectangular sensor surface of the sweep-type fingerprint sensor, and the straight line is located at a side of the long edge of the rectangular sensor surface such that a specific portion of the finger firstly passes through the straight line and then the sensor surface or firstly passes through the sensor surface and then the straight line.

7. The device according to claim 2, wherein the T/G mechanism comprises four rollers, which are arranged in two straight lines, which are substantially parallel to the long edge of the rectangular sensor surface of the sweep-type fingerprint sensor, and the sensor surface is located between the two straight lines.

8. The device according to claim 1, further comprising:
a panel, on which a U-shaped groove is formed, wherein the sweep-type fingerprint sensor and the T/G mechanism are arranged in the U-shaped groove.

9. The device according to claim 1, further comprising:
a micro switch in contact with the T/G mechanism such that the sweep-type fingerprint sensor is powered when the finger contacts the T/G mechanism.

10. The device according to claim 1, further comprising:
a speed sensor for sensing a rotating speed of the T/G mechanism and outputting a rotating speed signal to a microprocessor such that the microprocessor determines a minimum number of the fingerprint fragment images to be acquired according to the rotating speed signal.

11. The device according to claim 1, further comprising:
a displacement sensor for sensing a displacement of the T/G mechanism and outputting a displacement signal to a microprocessor, which determines a minimum number of the fingerprint fragment images to be acquired according to the displacement signal.

12. The device according to claim 10, wherein the T/G mechanism comprises a roller, and the speed sensor comprises:
an emitter for outputting an emitted signal; and
a receiver for receiving the emitted signal, which sequentially passes through a plurality of openings of the roller to cause a plurality of pulses as the rotating speed signal.

13. The device according to claim 11, wherein the T/G mechanism comprises a roller, and the displacement sensor comprises:
an emitter for outputting an emitted signal; and
a receiver for receiving the emitted signal, which sequentially passes through a plurality of openings of the roller to cause a plurality of pulses as the displacement signal.

14. The device according to claim 10, wherein the T/G mechanism comprises a roller, and the speed sensor comprises:
an emitter for outputting an emitted signal; and
a receiver for receiving the emitted signal, which is reflected from the roller to cause a plurality of pulses as the rotating speed signal.

15. The device according to claim 11, wherein the T/G mechanism comprises a roller, and the displacement sensor comprises:
an emitter for outputting an emitted signal; and
a receiver for receiving the emitted signal, which is reflected from the roller to cause a plurality of pulses as the displacement signal.
